(19) United States
(12) Patent Application Publication
(10) Pub. No.: US 2005/0029172 A1
(43) Pub. Date: Feb. 10, 2005

(54) Filter head and burner system incorporating same

(75) Inventors: Michael E. Buhl, Belvidere, IL (US); Dale L. Hunsberger, Rockford, IL (US); David Zierke, Rockford, IL (US); Bill Mitchell, Rockford, IL (US)

Correspondence Address: LEYDIG VOIT & MAYER, LTD, 6815 WEAVER ROAD, ROCKFORD, IL, 61114-8018, US

(73) Assignee: Suntec Industries Incorporated, Rockford, IL (US)

(21) Appl. No.: 10/636,117

(22) Filed: Aug. 7, 2003

(51) Int. Cl. B01D 35/00

(52) U.S. Cl. 210/133; 210/443; 210/433.1; 210/440

(57) ABSTRACT

The present invention is directed toward a filter head that is adapted to mount a filter between an upstream fluid supply and a downstream fluid pump such as might be used for an oil burner system that includes a combination of the filter head and the safety valve in a single unit that may be interposed at a location along an oil conduit. The filter head comprises a filter head housing having an inlet port and an outlet port and a filter mounting stub that is adapted to mount the filter thereto. The filter mounting stub provides a filter head entrance port and a filter head exit port fluidically between the inlet and the outlet ports for communication with the filter when mounted thereto. A safety valve is mounted in the filter head housing and is arranged fluidically between the inlet and outlet port of the filter head housing. The safety valve has open and closed positions and opens in response to vacuum pressure at the outlet port.

### FIELD OF THE INVENTION

The present invention pertains generally to filter mounting heads and safety valves in oil burner systems or other fluid systems.

### BACKGROUND OF THE INVENTION

As is disclosed in Model PRV-38 Oil Safety Valve Installation Information available from Suntec Industries, Inc., an oil burning system in its basic form typically includes an elevated tank that feeds fuel oil via gravity through a filter which is mounted along the oil conduit passageway via a filter mounting head to an oil burner which includes an oil pump such as any of those models manufactured and sold by Suntec Industries, Inc. The filter is arranged along the oil feed line and is mounted thereto with a filter mounting head to filter out and prevent contaminants from reaching the oil pump or burner.

A problem with gravity fed installations or other types of installations described in the aforementioned literature is that if there is a leak in the oil line, all of the oil contained in the tank can leak out through the leakage location(s). This can be particularly troublesome in residential and commercial buildings where the line leads to a burner on a furnace or boiler. In particular, with the oil line running into the house or building, all of the oil from the tank will leak into the home or building if the leak occurs along the line within the house or building.

To remedy this problem, often a safety valve such as the Model PRV-38 Oil Safety Valve (“PRV Valve”) commercially available from Suntec Industries, Inc. is mounted at a strategic location along the oil filter line. Oil under pressure or vacuum is supplied to the inlet port of the PRV Valve. Vacuum is required at the outlet port of the PRV Valve to open it and allow oil to flow. When a burner starts, the pump will supply the vacuum necessary which is communicated to the outlet port of the PRV Valve to open the PRV Valve. Any leak in the system between the PRV Valve and the oil pump of the oil burner prevents vacuum from being exerted at the outlet port of the valve and thereby prevents oil from flowing through the PRV Valve. Thus, when there is a leak between the PRV Valve and the oil pump for the oil burner, the PRV Valve remains shut thereby preventing oil from leaking through leakage locations. Accordingly, by mounting the PRV Valve strategically along the oil line, leakage into a house or building can be prevented even if there is a leak along the oil line downstream of the PRV Valve that runs through the house or building.

With this context provided, it will be seen that the present invention provides significant improvements and efficiencies over the existing prior art, which will readily be appreciated upon an understanding of the present invention.

### BRIEF SUMMARY OF THE INVENTION

The present invention is directed toward a filter head that is adapted to mount a filter between an upstream fluid supply and a downstream fluid pump such as might be used for an oil burner system that includes a combination of the filter head and the safety valve in a single unit that may be interposed at a location along an oil conduit. The filter head comprises a filter head housing having an inlet port and an outlet port and a filter mounting stub that is adapted to mount the filter thereto. The filter mounting stub provides a filter head entrance port and a filter head exit port fluidically between the inlet and the outlet ports for communication with the filter when mounted thereto. A safety valve is mounted in the filter head housing and is arranged fluidically between the inlet and outlet port of the filter head housing. The safety valve has open and closed positions and opens in response to vacuum pressure at the outlet port.

It is an advantage of the present invention that only a single unit needs to be mounted along a fluid plumbing line of a burner to provide for both safety valve and filter mounting functions. This reduces the cost to install a filter head and safety valve in a system and also reduces the number of different connections needed which can reduce the likelihood for leakage occurring.

The present invention is also directed toward an oil burner system incorporating the filter head as described above which includes the filter head interposed between an oil tank and an oil burner that has an oil pump that is adapted to pump fuel to the combustion chamber of the oil burner.

Other aspects, objectives and advantages of the invention will become more apparent from the following detailed description when taken in conjunction with the accompanying drawings.

### BRIEF DESCRIPTION OF THE DRAWINGS

FIG. 1 is a cross-sectional view of a filter head according to a preferred embodiment of the present invention.

FIG. 2 is a cross-section of the filter head similar to FIG. 1 but with the filter head being shown in reduced size and being shown with a filter cartridge mounted thereto.

FIG. 3 is a schematic representation of the filter head mounted fluidically between a tank and an oil burner in an oil burning system, with a filter mounted thereto, according to an embodiment of the invention.

### DETAILED DESCRIPTION OF THE INVENTION

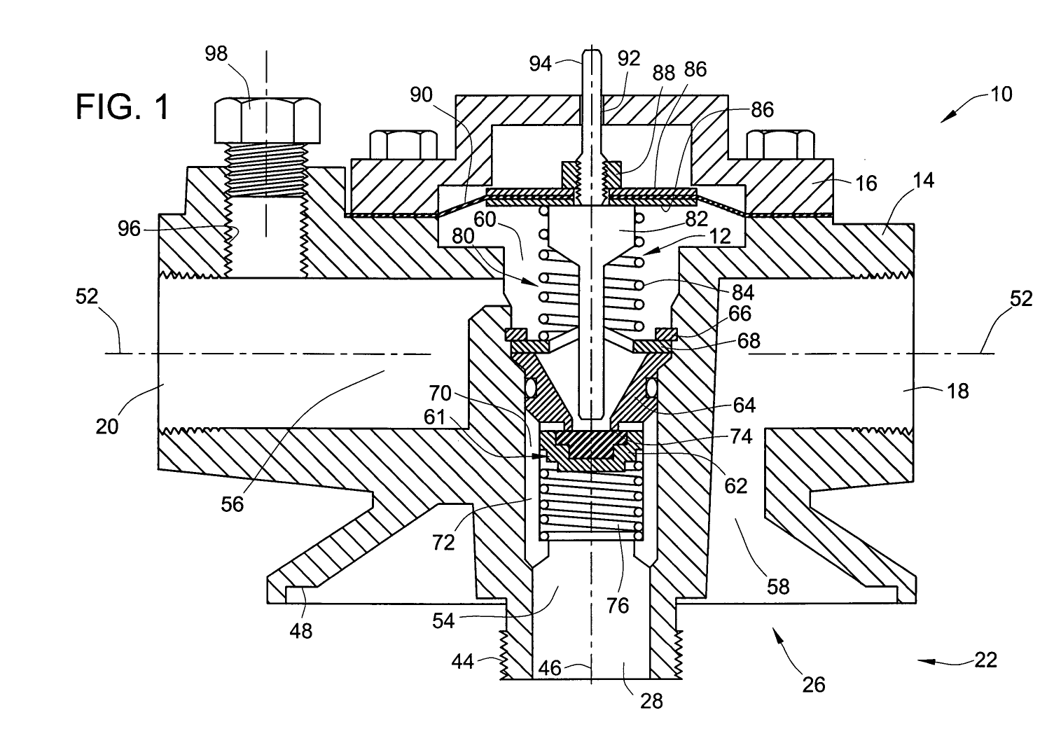

Referring to FIG. 1, an embodiment of the present invention has been disclosed as a filter head 10 that integrally includes a safety valve 12. The filter head 10 generally includes a filter housing which as shown may comprise a filter head body 14 and a cover plate 16. These components can be made of cast metal material and/or can also be machined.

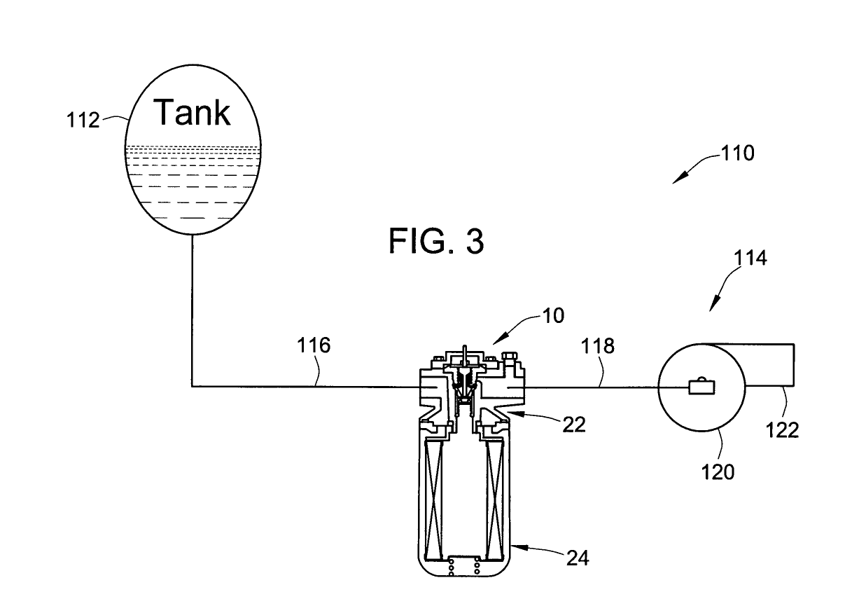

The filter head body 14 comprises a main threaded inlet port 18 for receiving fuel oil from a tank or booster pump and a main threaded outlet port 20 for outletting oil to a burner. The inlet and outlet ports 18 and 20 provide means for mounting the filter head to external plumbing lines such as might be used in the oil burner system shown in FIG. 3. The filter head body 14 also integrally provides a filter mounting stub 22 that facilitates mounting of a filter cartridge 24 fluidically between the inlet and outlet ports 18 and 20. To provide for fluid communication with the filter cartridge, the filter mounting stub includes a filter head exit port 26 and a filter head entrance port 28 for communicating with the filter cartridge 24.

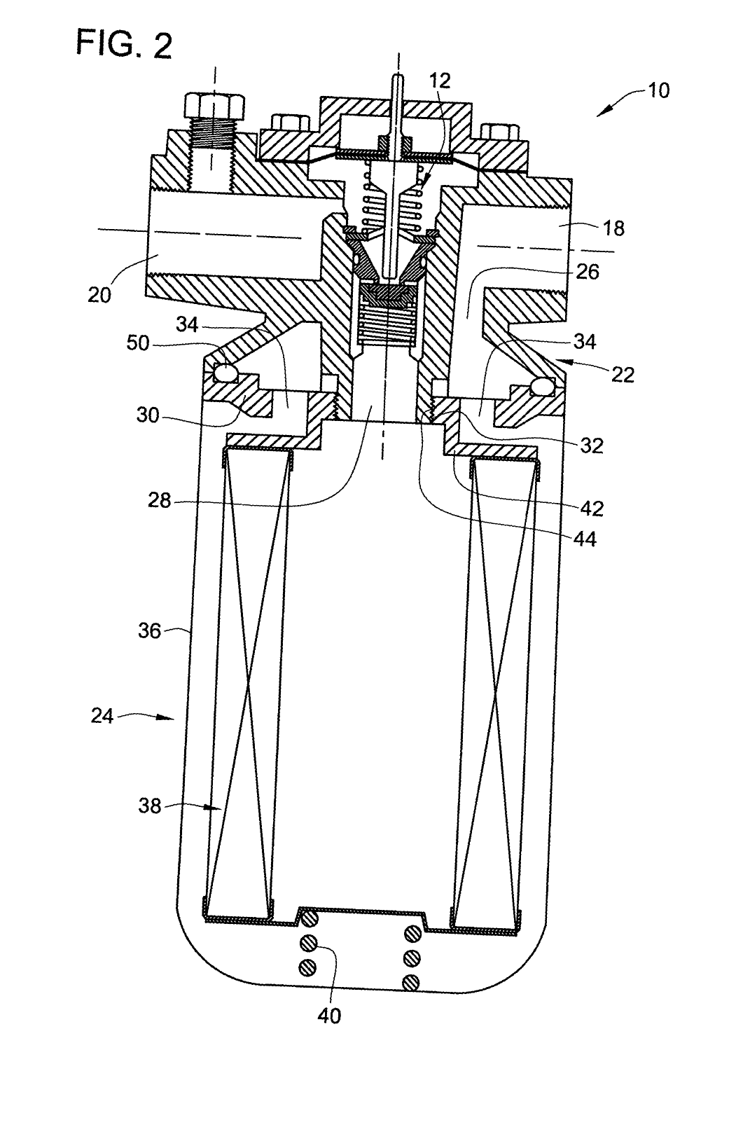

The filter cartridge can take one of a variety of forms. Referring to FIG. 2, the filter cartridge 24 is shown as the spin-on type to provide for easy maintenance. Accordingly, the filter cartridge 24 includes an endplate 30 having a central threaded outlet hole 32 and a plurality of radial inlet ports 34. An outer canister 36 is joined to the outer periphery of the endplate 30 by any conventional filter assembly techniques. The filter contains a cylindrical filter element 38 that is urged by a spring 40 toward the endplate 32. A spacer element 42 positions the cylindrical filter element 38 relative to the endplate 30 to allow for inlet flow through the radial inlet ports 34. In operation, fluid exits the filter head 10 through the filter head exit port 26, enters the filter cartridge 24 through the radial inlet ports 34 in the filter endplate 30, passes radially outward and then radially inward through the cylindrical filter element 38 whereby oil is filtered, then to a central chamber where it is collected and exits the filter through the central threaded outlet hole 32 and returns to the filter mounting head through the filter head entrance port 28.

As previously indicated, the filter cartridge 24 is shown as the spin-on type in which the entire filter cartridge 24 is removable, disposable and/or replaceable. To provide for a spin-on connection, and referring to FIGS. 1 and 2, the filter-mounting stub includes a central threaded hub 44 that is coaxial about a filter-mounting axis 46. The threaded hub 44 therefore integrally defines the filter head entrance port 28 therethrough. Accordingly, the filter head entrance port comprises an annular chamber that is defined radially between the central threaded hub 44 and the outer peripheral annular sealing flange 48. Also, an outer peripheral annular sealing flange 48 is provided concentric around the threaded hub 44 to provide a surface that can seal against the outer housing of the filter cartridge 24. Typically an annular gasket 50 will be arranged between the annular sealing flange 48 and the filter cartridge 24 to provide a seal and prevent leakage of oil to the external environment. The annular gasket 50 may either be secured to the filter head 10 and thereby be a reusable sealing gasket or can alternatively be part of the filter cartridge 24 and may be disposable.

Although one arrangement of a filter cartridge 24 and mounting stub 22 is shown, it will be readily appreciated that if desired, the outer housing for the filter cartridge 24 could be mounted to the mounting stub by other means such as by bolting on, clamps or other securing mechanism. Also, the outer housing for the filter cartridge 24 could be made as a reusable component (e.g. a filter bowl) that is releasably mounted to the stub such that only the filter element that contains the filter media providing for barrier filtration and/or other appropriate filtration is removable and disposable. Such other forms of filters can thus be used without departing from the present invention.

The inlet and outlet ports 18 and 20 extend along an axis 52 transverse relative to the filter-mounting axis 46. To connect the inlet and outlet ports 18, 20 to the filter head exit port 26 and filter head entrance port 28, passageways are provided through the filter head body 14 to complete the desired flow path. In particular, the filter head body 14 includes a central axial passage 54 coaxial about the filter mounting axis 46 that is connected to a transverse passage 56 to connect the filter head entrance port 28 with the outlet port 20. The filter head body 14 also provides an offset axial passage 58 that is offset from the filter axis 46 and connects the inlet port 18 with the annular filter head exit port 26.

Between the inlet and outlet ports 18, 20, the safety valve 12 is mounted in a valve chamber 60 which is defined by the filter head body 14. The central axial passage 54 and transverse passage 56 extend into and through the valve chamber 60. In the disclosed embodiment, the safety valve 12 includes a valve assembly 61 and a valve actuator assembly 80. The valve assembly 61 includes a valve closure element 62 which may comprise a rigid support element and a resilient sealing element as shown. The valve closure element 62 is arranged to be seated and closed against a valve seat element 64. As shown in the drawings, the valve seat element 64 is mounted with a retaining ring 66 which is secured in a groove formed in the valve chamber 60 that axially supports a washer/stem guide and the valve seat element 64. The other end of the valve seat element 64 is axially retained by a valve guide 70 that includes a cylindrical inner guide surface that guides that axial translation of the valve closure element 62. The valve guide includes axial passages 72 that communicate fluid around the valve closure element 62. The valve seat element 64 includes an annular seating surface that defines a through port therethrough. The valve guide may either be a separate component inserted into the central bore formed in the filter mounting body or it can be integrally cast or formed into the filter mounting body 14.

The valve closure element 62 is movable between open and closed positions. As shown in the drawings, the valve closure element is shown in a closed position seated against the annular seating surface 74 of the valve seat element 64. Fluid pressure or liquid oil pressure such as may be realized from a gravity fed tank as shown in FIG. 3 or via booster pump type systems as could be realized in other types of oil burner systems, may provide one means for keeping the valve closure element 62 closed against the valve seat element 64. Additionally, and because fluid pressures in different systems can vary in different oil burner systems even with gravity fed tanks, a spring 76 is provided to provide a reliable means for biasing the valve closure element 62 against the valve seat element 64 and thereby prevent oil from flowing from the inlet port 18 to the outlet port 20. As shown herein, the spring 76 acts directly upon the valve closure element 62. The spring 76 is supported by the filter head body 14 through a spring support stop provided by the valve guide 70. Additionally, if there were to be a consistent mounting orientation, gravity could also be used to tend to keep the valve closure element 62 normally in the closed position while the downstream burner or consumption location is idle.

As shown herein, the spring 76 is a metal coil spring. However, it will be appreciated that other forms of spring elements may also be used to include rubber resilient material or other media that stores a spring force to keep the valve closure element closed. Also, the spring could act indirectly on the valve through other components while still providing the desired bias.

The safety valve 12 also includes a valve actuator assembly 80 that is also mounted into the valve chamber 60. The valve actuator assembly 80 includes a valve actuator stem 82 that is axially aligned along the filter mounting axis 46 in spaced axial relation to the center opening through the annular seating surface 74 and the planar end sealing face of the valve closure element 62. The actuator stem 82 is urged axially away from the valve closure element via a spring 84. The spring 84 is supported by the filter head body 14 through the washer/stem guide 68 and urges a pair of support plates 86 that are mounted to the actuator stem 82 with a nut. The support plates 86 secure a flexible rubber diaphragm 90 therebetween. The cover plate 16 generally encloses the valve chamber 60 and traps the outer peripheral edge of the rubber diaphragm 90 between the cover plate 16 and the filter head body 14 to provide a sealed internal chamber and an external chamber exposed to ambient atmospheric pressure. Bolts are used to screw the cover plate 16 to the filter head body 14. As shown in the drawings, the valve actuator stem 82 extends through a hole 92 in the cover plate to provide an exposed indicating portion 94 on the actuator stem 82 that indicates that the valve is closed when the indicating portion projects from the cover plate 16 and that the valve is open when the indicating portion is partially withdrawn, flush or recessed into the hole 92 of the cover plate 16. With this arrangement, the support plates 86 and flexible diaphragm 90 are exposed to the oil pressure contained within the valve chamber 60 when in use, which is exposed to the pressure which is experienced at the outlet port 20. When a vacuum condition occurs at the outlet port 20 (such as may be caused by a downstream oil pump) which is sufficient to overcome the force of the spring 84, the flexible diaphragm 90 is sucked inwardly due to the vacuum pressure which in turn translates the actuator stem against the action of the spring 76 which causes the end of the actuator stem 82 to strike and open the valve closure element 62 away from the seat and against the action of the valve spring 76. Movement of the actuator stem 82 is constrained by virtue of respective stop surfaces provided by the cover plate 16 and the filter head body 14 which will strike the support plates 86 and thereby limit translation or movement of the actuator stem 82.

Finally, preferably a vacuum gauge port 96 is provided proximate the outlet port 20 and in any event fluidically between the outlet port and the valve 12 to receive a vacuum gauge which can be used to monitor vacuum pressure. A plug 98 is shown mounted into the vacuum gauge port 96 to keep this port closed when not in use.

Turning to FIG. 3, a schematic representation of an implementation of the present invention is schematically illustrated. As shown in FIG. 3, an oil burner system 110 incorporates the filter head 10 of the present invention fluidically in series between an oil tank 112 and an oil burner 114. Other components, booster pumps and the like may be arranged along this oil circuit if desired. As shown herein, the oil tank 112 contains fuel oil. An upstream conduit 116 connects the tank 112 to the inlet port 18 of the filter head 10. A downstream conduit 118 connects the outlet port 20 to the oil pump 120 for the oil burner 114. In operation, this oil pump 120 will produce the vacuum pressure which is experienced at the outlet port 20 during operation to open the safety valve 12 and thereby allow oil to flow from the tank through the filter head 10, the filter cartridge 24 and to the oil burner where it is combusted in a combustion chamber 122.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter head adapted to mount a filter between an upstream fluid supply and a downstream fluid pump, the filter head comprising:
a filter head housing having an inlet port and an outlet port, the filter head having a filter mounting stub adapted to mount the filter thereto, the filter mounting stub defining a filter head entrance port and a filter head exit port between the inlet and the outlet ports for communication with the filter;
a valve closure element interposed between the inlet and the outlet ports having open and closed positions, the valve closure element being biased by a spring element to a closed position; and
a valve actuator arranged to open the valve closure element against the spring element in response to vacuum pressure between the valve closure element and the outlet port.

2. The filter head of claim 1, wherein the valve closure element is arranged between the filter head entrance port and the outlet port.

3. The filter head of claim 2, wherein the filter mounting stub includes an annular flange and a central hub coaxially contained therein about a filter mounting axis, the central hub surrounding the filter entrance, the filter head exit port being defined radially between the annular flange and the central hub, further comprising an axial passage along the axis connecting the filter head entrance port with a transverse passage leading to the outlet port, and wherein the valve closure element is disposed in the axial passage.

4. The filter head of claim 3, wherein the inlet and outlet are arranged transversely relatively to the filter mounting axis.

5. The filter head of claim 1, wherein the filter head housing comprises a body and a cover plate, the body defining a valve chamber and defining each of the inlet and outlet ports and each of the filter entrance and exit ports all in a single unitary cast member.

6. The filter head of claim 5, further comprising an outlet vacuum gauge port defined in the body fluidically between the valve closure element and the outlet port.

7. A filter head adapted to mount a filter between an upstream fluid supply and a downstream fluid pump, the filter head comprising:
a filter head housing having an inlet port and an outlet port, the filter head having a filter mounting stub adapted to mount the filter thereto, the filter mounting stub defining a filter head entrance port and a filter head exit port between the inlet and the outlet ports for communication with the filter; and
a safety valve mounted in the filter head housing arranged fluidically between the inlet port and the outlet port, the safety valve having closed and open positions, the safety valve opening in response to vacuum pressure at the outlet port.

8. The filter head of claim 7, wherein the safety valve includes: a valve closure element movable toward and away from a valve seat, means for biasing the valve closure element against the valve seat, and means responsive to vacuum pressure at the outlet port for actuating the valve closure element away from the valve seat.

9. The filter head of claim 8, wherein the valve closure element is arranged between the filter head entrance port and the outlet port.

10. The filter head of claim 9, wherein the filter mounting stub includes an annular flange and a central hub coaxially contained therein about a filter mounting axis, the central hub surrounding the filter entrance, the filter head exit port being defined radially between the annular flange and the central hub, further comprising an axial passage along the axis connecting the filter head entrance port with a transverse passage leading to the outlet port, and wherein the valve closure element is disposed in the axial passage.

11. The filter head of claim 10, wherein the inlet and outlet are arranged transversely relatively to the filter mounting axis.

12. The filter head of claim 7, wherein the filter head housing comprises a body and a cover plate, the body defining a valve chamber receiving the safety valve and defining each of the inlet and outlet ports and each of the filter entrance and exit ports all in a single unitary cast member.

13. The filter head of claim 7, further comprising an outlet vacuum gauge port defined in the filter head housing fluidically between the safety valve and the outlet port.

14. The filter head of claim 13, further comprising visual indicating means for indicating whether the safety valve is open or closed.

15. An oil burner system, comprising:
a oil tank containing fuel oil;
an oil burner having a combustion chamber arranged downstream of the oil tank, and an oil pump adapted to pump fuel to the combustion chamber; and
a filter head interposed between the oil tank and the oil burner, the filter head connected by an upstream network to the oil tank and to the oil pump via a downstream network, the filter head including:
(a) a filter head housing having an inlet port and an outlet port, the filter head having a filter mounting stub having an oil filter mounted thereto, the filter mounting stub defining a filter head entrance port and a filter head exit port between the inlet and the outlet ports for communication with the filter, the oil filter adapted to filter and communicate oil from the filter head entrance port to the filter head exit port; and
(b) a safety valve mounted in the filter head housing arranged fluidically between the inlet port and the outlet port, the safety valve having closed and open positions, the safety valve opening in response to vacuum pressure at the outlet port.

16. The oil burner system of claim 15, wherein the safety valve includes: a valve closure element interposed between the inlet and the outlet ports having open and closed positions, the valve closure element being biased by a spring element to a closed position; and a valve actuator arranged to open the spring element against the spring element in response to vacuum pressure between the valve closure element and the outlet port.

17. The filter head of claim 16, wherein the valve closure element is arranged between the filter head entrance port and the outlet port.

18. The filter head of claim 17, wherein the filter mounting stub includes an annular flange and a central hub coaxially contained therein about a filter mounting axis, the hub surrounding the filter entrance, the filter head exit port being defined radially between the annular flange and the central hub, further comprising an axial passage along the axis connecting the filter head entrance port with a transverse passage leading to the outlet port, and wherein the valve closure element is disposed in the axial passage.

19. The filter head of claim 18, wherein the inlet and outlet are arranged transversely relatively to the filter mounting axis.

20. The filter head of claim 15, wherein the filter head housing comprises a body and a cover plate, the body defining a valve chamber for receiving the safety valve and defining each of the inlet and outlet ports and each of the filter entrance and exit ports all in a single unitary cast member.

21. The filter head of claim 15, further comprising an outlet vacuum gauge port defined in the filter housing fluidically between the safety valve and the outlet port.

22. A filter head adapted to mount a filter between an upstream oil supply and a downstream oil pump in an oil burner system, the filter head comprising:
a filter head housing including a cover plate and a filter head body, the filter head body providing a filter mounting stub for mounting the filter, the filter mounting stub including an annular flange and a threaded central hub coaxially contained therein about a filter mounting axis, the threaded hub defining a filter head entrance port, an annular shaped filter head exit port being defined radially between the annular flange and the central hub, the filter head body further defining an inlet port, an outlet port, an actuation chamber, a first axial passage along the axis to connect the filter inlet port with the actuation chamber, a second axial passage offset from the axis to connect the inlet port with the filter head exit port, and a transverse passage extending transverse relative to the axis to connect the actuation chamber with the outlet port, the cover plate enclosing the actuation chamber;
a valve assembly mounted in the axial passage comprising a valve seat element mounted in the axial passage, a valve closure element disposed in the axial passage, and the spring element biasing the valve closure element axially away from the threaded hub against the valve seat to close the axial passage; and
a valve actuator assembly mounted in the actuator chamber comprising a flexible diaphragm, a spring means and an actuating stem, the actuating stem being axially aligned with the valve closure element and being carried by the diaphragm, the spring means biasing the actuating stem away from the valve closure element, the diaphragm being retained between the cover plate and the filter head body and separating the actuator chamber into an ambient side and an a working side, wherein a predetermined magnitude of vacuum pressure experienced in the actuation chamber on the ambient side drives the diaphragm and actuator stem axially to strike the valve closure element and open the axial passage.
